(19) United States
(12) Patent Application Publication
(10) Pub. No.: US 2014/0289646 A1
(43) Pub. Date: Sep. 25, 2014

(54) Cross-Platform Conferencing Interface

(71) Applicant: NZS INC., San Diego, CA (US)

(72) Inventor: Sufian Munir, San Diego, CA (US)

(73) Assignee: NZS INC., San Diego, CA (US)

(21) Appl. No.: 14/220,760

(22) Filed: Mar. 20, 2014

Related U.S. Application Data
(60) Provisional application No. 61/804,457, filed on Mar. 22, 2013.

(51) Int. Cl. H04L 29/06

(52) U.S. Cl. CPC H04L 65/403
USPC 715/753

(57) ABSTRACT

A cross-platform conferencing interface includes a graphical user interface (GUI) that displays multiple conferencing options, including a web conferencing option. Beginning at a home screen of the conferencing interface, a user can connect a web conference call through one of multiple web conference applications, or providers, in as few as two clicks. A first click can cause a web conference screen usable with multiple different conferencing applications to be displayed. The second click can initiate a call to a selected contact associated with the particular web conferencing application. The web conference screen acts as a front-end application program interface (API) for the web conferencing application or provider, but the call is connected using the application's resources. The interface can be implemented as a dedicated conferencing device that provides video conferencing, audio conferencing, web conferencing, and an interactive whiteboard.

### CROSS REFERENCE TO RELATED APPLICATIONS

The present U.S. Utility Patent Application claims priority pursuant to 35 U.S.C. §119(e) to U.S. Provisional Application No. 61/804,457, entitled “MULTI-INTERFACE INTERACTIVE VIRTUAL CONFERENCING DEVICE”, filed Mar. 22, 2013, which is hereby incorporated herein by reference in its entirety and made part of the present U.S. Utility Patent Application for all purposes.

### BACKGROUND

1. Technical Field

This invention relates generally to audio, video, and web conferencing, and more particularly to integrating access to multiple different conferencing platforms, applications, and providers.

2. Description of Related Art

Current business practices often require many people located in widely separated geographical locations to collaborate on projects, demonstrate products, analyze problems in a group setting, provide status updates, conduct interviews, and engage in other activities traditionally carried out using in-person conferences. Various conferencing applications and providers have emerged to provide businesses with the ability to remotely conference with multiple individuals. Many of these conferencing applications require all of the conference attendees to be using the same conferencing application.

When only the same few individuals consistently attend the same conferences, uniform use of the same conferencing application is not generally an issue. However, when the attendees are often different and unpredictable, the use of the same conferencing application can become more problematic. For example, a business might have 3 different clients that prefer to use 3 different conferencing applications. The business' employees might also have their own preferences, and be familiar with using conferencing applications other than those preferred by the customers. This problem can be exacerbated when, due to cost or information technology considerations, the business provides a conference room with a single conferencing device for local conference attendees. In that case, each different conference host might be forced to use a conferencing application unfamiliar to him, or one that is less-preferred by the client.

It is apparent, therefore, that current techniques and systems used for scheduling radio broadcasts are less than perfect.

### BRIEF DESCRIPTION OF THE SEVERAL VIEWS OF THE DRAWING(S)

FIG. 1 is a diagram of a graphical user interface (GUI) displaying a home screen, according to various embodiments of the present disclosure;

FIG. 2 is a diagram illustrating a web conferencing screen for a first web conference application/provider, according to various embodiments of the present disclosure;

FIG. 3 is a diagram illustrating a uniform web conferencing screen for a second web conference application/provider, according to various embodiments of the present disclosure;

FIG. 4 is a diagram illustrating a meeting screen displayed after a conference is initiated using the web conferencing screen for the second web conference application/provider illustrated in FIG. 3, according to various embodiments of the present disclosure;

FIG. 5 is a diagram illustrating a uniform web conferencing screen for a third web conference application/provider, according to various embodiments of the present disclosure;

FIG. 6 is a diagram illustrating a meeting screen displayed after a conference is initiated using the web conferencing screen for the third web conference application/provider illustrated in FIG. 5, according to various embodiments of the present disclosure

FIG. 7 is a GUI illustrating a General Settings window displayed after selecting the Settings icon in the home screen illustrated in FIG. 1, according to various embodiments of the present disclosure;

FIG. 8 is a diagram illustrating a web conferencing screen including a web conferencing settings window that allows settings to be entered for multiple web conferencing applications, services, and providers, according to various embodiments of the present disclosure;

FIG. 9 is a flow chart illustrating a method, according to various embodiments of the present disclosure;

FIG. 10 is a block diagram of a dedicated conferencing device, according to various embodiments of the present disclosure;

FIG. 11 is a block diagram of a processing system, which can be used to implement devices and systems according to various embodiments of the present disclosure.

### DETAILED DESCRIPTION

Various devices, systems, and methods described herein can be used to implement a cross-platform conferencing interface that provides simplified access to any of multiple different conferencing applications or providers. The cross-platform conferencing interface can be realized as a non-transitory computer readable medium configured to be run on any of various computer platforms at individual work stations, laptops, tablets, phones, or other devices. In some embodiments, the cross platform conferencing interface can be implemented as a dedicated conferencing device that includes the hardware and software needed to implement the techniques discussed herein.

The interface includes a graphical user interface (GUI) displaying multiple conferencing options on a home screen. The conferencing options include, in some embodiments audio conferencing, web conferencing, video conferencing, and an interactive whiteboard, although additional or fewer options can be presented. In at least some embodiments, a user can establish a conference call using the resources of an available conferencing application in as few as two clicks by first selecting a conferencing option from the home screen, and then selecting a contact from a conference screen displayed in response to the first selection.

In at least some embodiments, the cross-platform conferencing interface acts as a single front-end application program interface (API) for multiple different conferencing applications or providers. In at least some embodiments, the web conference screen has a uniform layout configured for use with two or more different web conferencing providers, services, and applications. In some such cases, the cross-platform conferencing interface obtains user input and passes the user input to a particular application for processing and conference connection.

The terms “conference,” “call,” “conference call,” and derivatives of these terms are used interchangeably herein, unless otherwise specified or required by the contest of their use, to refer to establishing a communication path between one or more individuals using workstations, smart phones, tablets, laptops, dedicated conferencing devices, or the like over any suitable communication network. The terms “conference,” “call,” and “conference call,” include video calls, audio calls, audio-video calls, screen sharing, and similar collaborative sharing of information to and between participants of a conference.

The term “web conference” is intended to a conference conducted via an analog or packet-switched communication network. A web conference generally permits sharing of audio and visual content. However, unless otherwise specifically stated, a call established via the web conference function of the cross-platform interface is considered to be a web conference for purposes of this disclosure, even if only audio or visual content is actually shared among participants of the call.

The term “resources,” when used to refer to resources of a conference provider or conference application, refers to back-end, underlying functionality provided by the conference application or provider, including handling call connections and disconnections; transfer of video and audio content; encryption, encoding, and other processing of transferred content; and similar functionality. In at least some embodiments, the phrase “resources of the application,” and similar phrases specifically excludes front end functionality, such as displaying a user interface and collecting user input directly from a user, without going through the cross-platform conferencing interface.

As used herein, the term “click” is not intended to be interpreted narrowly, but instead refers broadly to activating a user selectable object using any suitable input means. For example, a “click” does not necessarily require use of a mouse; where a touch screen is used, a user can “click” on a displayed object by tapping the screen, or by performing some other suitable gesture. In some embodiments, where a user's movements are monitored remotely, a click can be any motion or gesture that serves the same basic function performed by a mouse click.

As used herein, the term “communication target” is used herein to refer user contacts, t individuals, groups, meetings, or devices having contact information accessible to the cross-platform conferencing interface, or to a conferencing application, service, or provider to which the cross-platform conferencing interface communicates.

As used herein, the phrase “uniform layout,” when used in the context of a conferencing interface includes conferencing interfaces having substantially the same number and type of display areas, tiles, panels, fields, user selectable objects, and the like, where those display areas, tiles, panels, fields, user selectable objects, and the like have substantially similar functionality and exhibit substantially similar behavior. Note that uniform layout does not require the exact same content to be displayed in each display area, tile, panel, field, user selectable object, etc. Furthermore, a conferencing interface is still considered to have a uniform layout even if different users employ tools provided in conjunction with the conferencing interface to customize the interface.

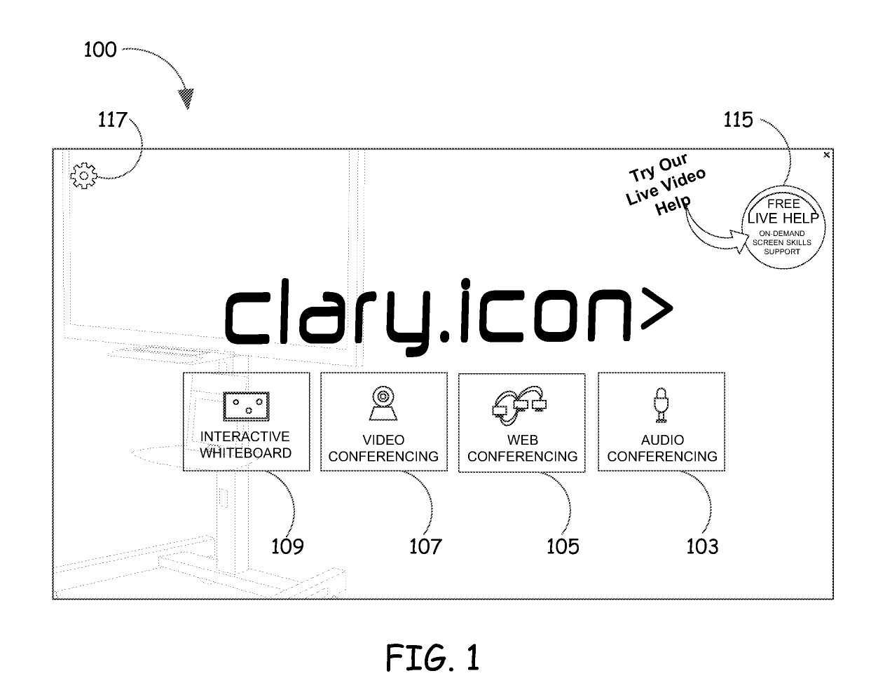

Referring first to FIG. 1, a diagram of a graphical user interface (GUI) displaying a home screen 100 is illustrated and discussed according to various embodiments of the present disclosure. Home screen 100 includes multiple user selectable objects that allow selection of various conferencing options. Audio conferencing object 103 can be selected to display an audio conferencing screen, web conferencing object 105 can be selected to display a web conferencing screen, video conferencing object 107 can be selected to display a video conferencing screen, and interactive whiteboard object 109 can be selected to display an interactive whiteboard. Home screen 100 also includes help object 115, which can be used to access technical support; and settings object 117, which can be selected to display a settings screen. Additional or fewer user selectable objects can be included on home screen 100.

In various embodiments, user input received from home screen 100, for example clicking on one of the user selectable objects 103, 105, 107, and 109 represents the first of two user inputs that are used to connect a call. In some such embodiments, clicking on one of the user selectable conferencing objects 103, 105, 107, or 109 causes the GUI to display a conferencing screen, from which second user input selecting a contact, can be obtained.

In some embodiments, the GUI displaying home screen 100 is generated by one or more computers running any of several commercially available operating system platforms, for example Microsoft Windows® operating system. The computer can be configured to run multiple conferencing applications associated with the user selectable conferencing objects 103, 105, 107, and 109. For example, video conferencing object 107 can be associated with one, two, or more video conferencing applications, and activating video conferencing object 107 can launch a front-end user interface to be used with one of those applications. Similarly, audio conferencing object 103 can be associated with one or more audio conferencing applications or providers, web conferencing object 105 can be associated with one or more web conferencing applications or providers, and interactive whiteboard object 109 can be associated with one or more interactive whiteboard applications or providers.

In some embodiments, highlighting or selecting one or more of the user selectable conferencing objects 103, 105, 107, and 109 can cause home screen 100 to display various drop down menus, objects or screens that provide expanded functionality. For example, interactive whiteboard object 109 can be expanded to provide a variety of modules, such as report generation, list and note taking, email integration, and other functionality that enhances conferencing collaboration.

In some embodiments, help object 115 can be selected by a user to connect directly to live, interactive support. If, upon pressing help object 115, the computer determines that no network connection is active or available, a screen including contact phone numbers can be presented to the user, along with instructions about how to contact technical support. In some embodiments, automated troubleshooting software local to the machine can be launched if no connection can be established with live technical support. The live technical support can include a chat window, a video conference, web conference, or audio conference connection with technical support. The connection to technical support can be made via one of the conferencing services available via the cross-platform conferencing interface, or via a separate technical support application.

In some embodiments, information regarding the computing platform on which the cross-platform conferencing interface is running can be sent to a technical support representative, who can then call initiate contact with the user using an external telephone number, via the cross-platform conferencing interface, or via another program running on the user's computer, but outside of the cross-platform conferencing interface.

Yet other implementations provide for a help menu to be presented, requesting user identification of the issue with which they need assistance. For example, a user might request assistance with establishing a web conference, or need help with a specific feature of the interactive whiteboard. The user might also have questions about how an interface device, such as a wireless touchpad, can be used to access particular features. In some cases, the help menu can include a frequently asked questions (FAQ) section. Once the user identifies the issue, the provided information can be provided to a technical support function, and an appropriate help technician can be provided.

In at least some embodiments, different levels of support can be provided to a user in response to activating help object 115. For example, a premium member might have access to 24 hour live interactive support that allows a technician to take control of the screen and provide real-time troubleshooting or tutorial services. A standard member might receive 24 live chat sessions with a technician. In yet other embodiments, all registered users can receive a predetermined number of help sessions free of charge. Other suitable responses to activating help object 115 can be provided in various embodiments.

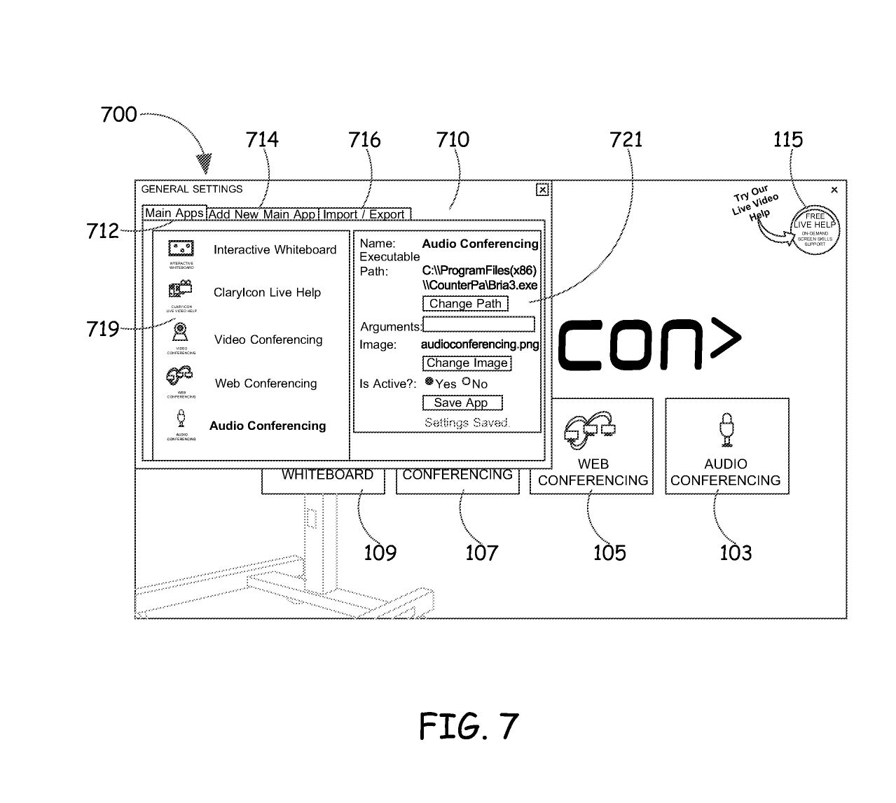

In response to selecting settings object 117, any of various settings screens can be displayed, allowing a user to enter defaults, preferences, account information or the like. Various embodiments of a general settings window are discussed subsequently with respect to FIG. 7.

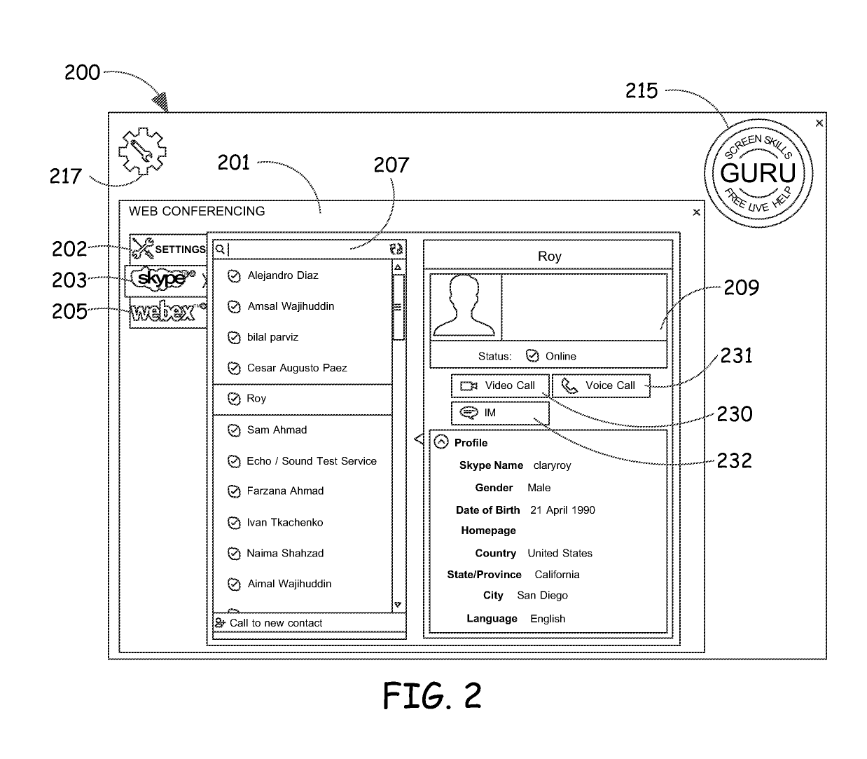

Referring next to FIG. 2 a web conferencing screen 200 associated with a first web conferencing provider is illustrated and discussed according to various embodiments of the present disclosure. As noted above with respect to FIG. 1, selection of a user selectable conferencing object 103, 105, 107, and 109 can cause a conferencing screen to be displayed. The following discussion focuses primarily on web conferencing screens displayed in response to selection of web conferencing object 105, but the discussion can apply equally to screens displayed in response to selection of audio conferencing object 103, video conferencing object 107, and interactive whiteboard object 109.

Web conferencing screen 200 includes help object 215, settings object 217, and web conferencing window 201. Web conferencing window 201 includes contact list area 207, which lists contacts associated with the active conferencing application or service; contact details area 209, which displays the details of a contact highlighted in contact list area 207; settings selector 202, which can be activated to display settings pertinent to web conferencing screen 200; first application selector 203, which allows selection of Skype™ as the active conference provider; and second application selector 205, which allows selection of WebEx™ as the active conference provider. In the illustrated embodiment first application selector 203 is active, indicating that the web conferencing screen 200 is configured for use with the Skype™ web conferencing application or service.

In at least some embodiments, a preferred web conferencing service or application can be selected as default through a settings screen (not illustrated) launched in response to a selection of settings object 217. A default conferencing application will, in some embodiments, be used as the active application to be displayed in web conferencing window 201 each time web conferencing screen 200 is displayed in response to selecting web conferencing object 105 (FIG. 1) from home screen 100 (FIG. 1). In this way, the number of user interactions required to initiate a call can be minimized or reduced. Thus, for example, from home screen 100 (FIG. 1), only a single click is required to reach the conferencing screen associated with a preferred conferencing application or service.

Activation of settings object 217 can also allow a user to change various display properties of web conferencing screen 201, such as which of the settings selectors 202, 203, and 205 should be displayed, in which order the settings selectors should be displayed, and a priority order of web conference applications indicating a preferred web conference application, a second preferred web conference application, and so on. Other display properties that can be set using settings object 217 include color, size, and font used for displaying various objects; text labels of various objects, particular panes and areas to be displayed, and the like.

Web conferencing screen 200 is configured to simulate an interface normally provided by the active web conferencing provider, service, or application being displayed in web conferencing window 201. The interface may or may not exactly duplicate the application interface being simulated, but even if the interface shown in web conferencing window 201 is not an identical simulation, various embodiments will provide sufficient input options to allow a user to access all, or substantially all, of the underlying functionality provided by the active conferencing application.

The interface shown in web conferencing window 201 is, in some embodiments, an application program interface (API) that obtains user input and forwards that user input to the active conferencing application for action—it is the conferencing application itself that provides the communication functionality. For example, if a user clicks on one of the user identifiers in contact list area 207, the interface shown in web conferencing window 201 can send information identifying the selected contact to the Skype™ application. The Skype™ application can then connect a conference call to the selected contact.

In addition to sending information to the Skype™ application, the interface shown in conferencing window 201 can monitor the status of the call or conference to determine whether or not the call successfully connected or the conference was successfully established. To monitor the conference call status, the interface shown in web conferencing window 201 can, in some instances, rely on a status reported by the Skype™ application. Thus, if the Skype™ application determines that the conference call did not go through, web conferencing window 201 can display an appropriate indication that may or may not be the same as the indication that would otherwise be provided by the Skype™ application's native interface.

In some embodiments, rather than simply displaying a call-failed indicator in response to receiving call-failed notification from Skype™, or whichever conferencing application is currently active, the cross-platform conferencing interface can trigger a technical support function similar to the technical support function provide in response to activating help object 215. In at least one embodiment, an automated behind-the-scene diagnostic process can be performed prior to or during connection to a live, interactive technical support session with a representative. The information from the diagnostic process can be used to assist the representative in diagnosing the connection issue. The technical support session need not be launched if the diagnostic process indicates that the call was simply not answered. For example, if a call fails to connect, help object 215 can be flashed, and a message, such as “Do you want help connecting this call?” can be displayed. In other examples, if the call does not connect simply because the intended recipient of the call fails to answer, a “No Answer” indicator can be shown instead of launching the technical support function.

In various embodiments, access to the technical support function can be offered to a user in response to a failure to connect or establish a conference. The technical support function can include, but is not limited to, connecting a user to a live audio-visual feed of a technical support representative. Once connected to the technical support representative, the user can authorize the representative to assume control of the computer being used to implement the cross-platform conferencing interface, so that problems can be more easily diagnosed with minimal effort on the part of the user.

In at least one embodiment, a user's selection of a contact from contact list area 207, automatically initiates an attempt to connect a call to that person, and is considered to be the second user input. In other embodiments, a recently called contact, or a contact automatically selected by other suitable means, can be highlighted in the contact list area 207, and selection of one of the video call button 230, or voice call button 231 can be considered the second user input that initiates a call to the contact.

In at least one embodiment, the active web conferencing application controls display of contacts, however, in some implementations, contacts from any available web conferencing application, or from email or other applications, can be displayed in the contact list window of an active web conferencing application. The cross-platform conferencing interface can, in some instances, perform a check of the contacts prior to displaying them, and only display contacts having the information needed to attempt a call using the active web conferencing application.

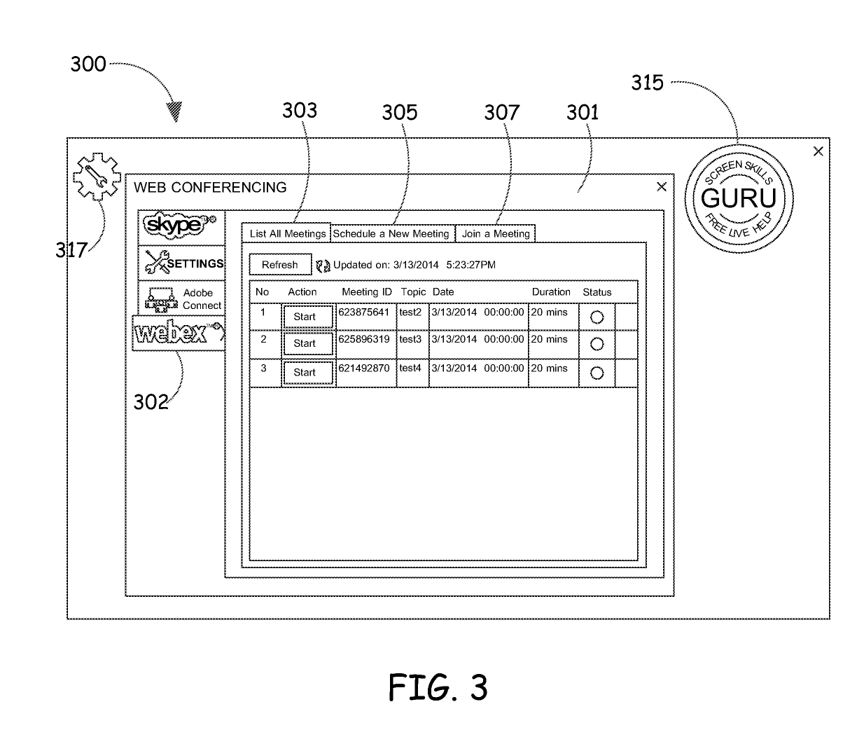

Referring next to FIG. 3 a uniform web conferencing screen 300 for a second web conference application, provider, or service, will be discussed according to various embodiments of the present disclosure. Web conferencing screen 300 includes help object 315, settings object 317, and uniform web conferencing window 301. Web conferencing window 301 shows application selector 302 as highlighted to indicate that WebEx™ is the active conferencing application or service. Web conferencing window 301 is organized to simulate an interface display native to the WebEx™ application, and includes meeting list tab 303, which lists all pending WebEx™ meetings; schedule new meeting tab 305, which can be selected to allow scheduling of a new conference; and join a meeting tab 307, which can be selected to allow a user to join a meeting already in progress.

Help object 315 and settings object 317 perform functions similar to help object 215 and settings object 217. For example, help object 315 can be used to launch a help function in which the user is connected to a live, interactive, audio-visual technical support feed. Settings object 517 can be selected to launch a settings screen (not illustrated) that collects user input and preferences used to customize which application selectors, e.g. Skype™, Settings, Adobe Connect™, and WebEx™ are presented, and an order in which they are displayed.

Note that web conferencing window 301, unlike web conferencing window 201 (FIG. 2), does not display a list of individual contacts, but instead displays a list of meetings, where the list of meetings are one type of communication target. In some embodiments, selecting a start button corresponding to one of the displayed meeting identifiers will still result in the WebEx™ application using its own resources to establish a conference associated with a communication target—in this example the meeting identifier, or a user contact invited to the meeting. Selection of one of the start buttons can be considered to be the second user input, thus allowing a conference to be established in as few as two clicks from home screen 100 (FIG. 1).

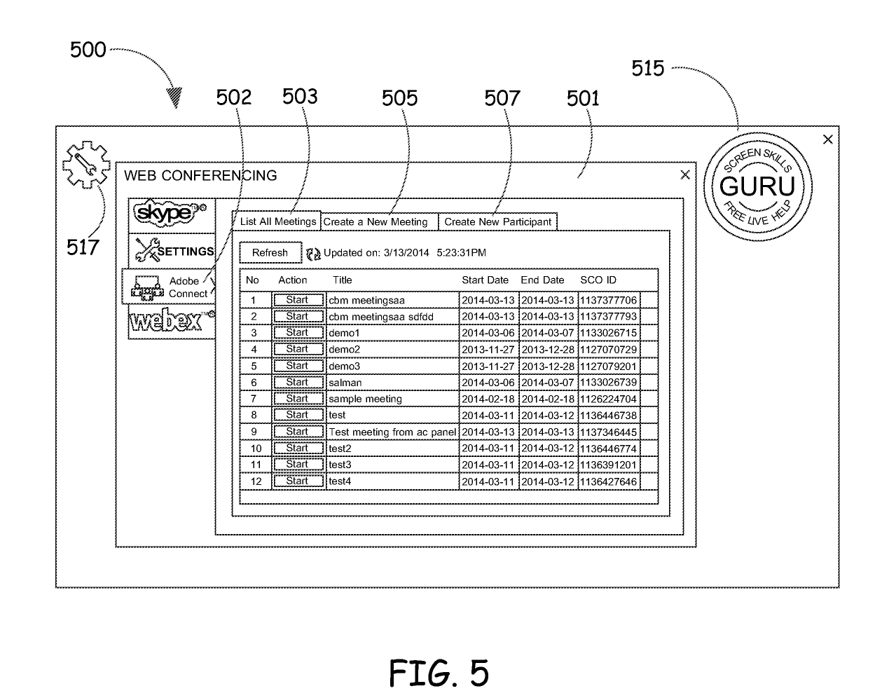

In at least some embodiments, uniform web conferencing screen 300 has the same layout used by other web conferencing applications. An example of another uniform web conferencing screen 500 is discusses subsequently with respect to FIG. 5. Because the layout of uniform conferencing window 301 is uniform with conferencing windows used in conjunction with other web conferencing applications, users able to use web conferencing window 301 to connect to a conference should have little difficulty connecting to other web conferencing applications. In some embodiments, the same sequence of actions will result in an attempt to connect to a conference, regardless of the specific web conferencing application being used.

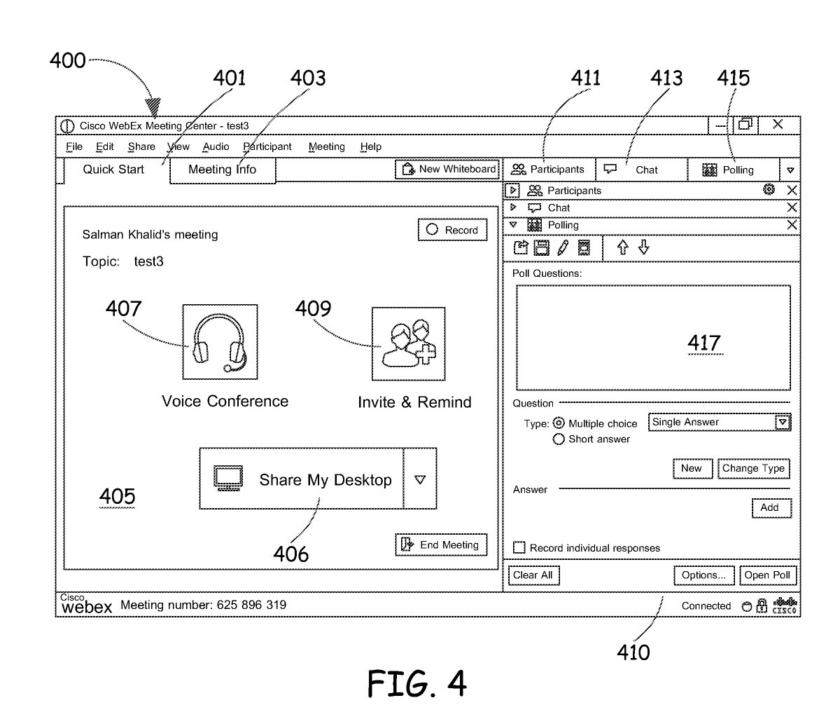

Referring next to FIG. 4 web meeting screen 400, displayed in response to a conference being initiated using web conferencing screen 300 (FIG. 3), is illustrated and discussed according to various embodiments of the present disclosure. Web meeting screen 400 includes main area 405, including quick start tab 401 and meeting information tab 403, and participant area 410. Main area 405 is illustrated with quick start tab 401 active, and displays user selectable objects, such as: voice conference button 407, invite and reminder button 409, and share my desktop button 406. Participant area 410 includes participants tab 411, chat tab 413, and polling tab 415, which is shown as active, and therefore displays polling question tile 417. In some embodiments, web meeting screen 400 can be provided by the selected conferencing application, in this case WebEx™, while in other embodiments web meeting screen 400 is provided by the cross-platform conferencing interface.

Referring next to FIG. 5 a uniform web conferencing screen 500 for use with Adobe Connect™ is illustrated and discussed according to various embodiments of the present disclosure.

Thus, Web conferencing screen 500 includes help object 515, settings object 517, and web conferencing window 501. Help object 515 and settings object 517 perform functions similar to help object 315 and settings object 317. Web conferencing window 501 shows application selector 502 as highlighted to indicate that Adobe Connect™ is the active conferencing application or service. Web conferencing window 501 is organized to simulate an interface display native to the Adobe Connect™ application, and includes meeting list tab 503, which lists all pending Adobe Connect™ meetings; create new meeting tab 505, which can be selected to allow creation of a new conference; and create new participant tab 507, which can be selected to allow a new participant or user contact to be created.

Web conferencing screen 500 is uniform with web conferencing screen 300 (FIG. 3), and includes substantially similar selectors, tabs, user selectable objects, and meeting fields, each having substantially similar functionality to corresponding portions of web conferencing screen 300, which was discussed previously with respect to FIG. 3. Similar to web conferencing window 301 (FIG. 3), Web conferencing window 501 displays a list of meetings, where the list of meeting titles, which are an example of communication targets. In some embodiments, selecting a start action corresponding to one of the displayed meeting titles will result in the Adobe Connect™ application using its own resources to establish a conference associated with a communication target—in this example the meeting title, or a user contact invited to the meeting. Selection of a start action can be the second user input of two user inputs that allow the cross-platform conferencing interface to establish a conference in as few as two clicks from a home screen.

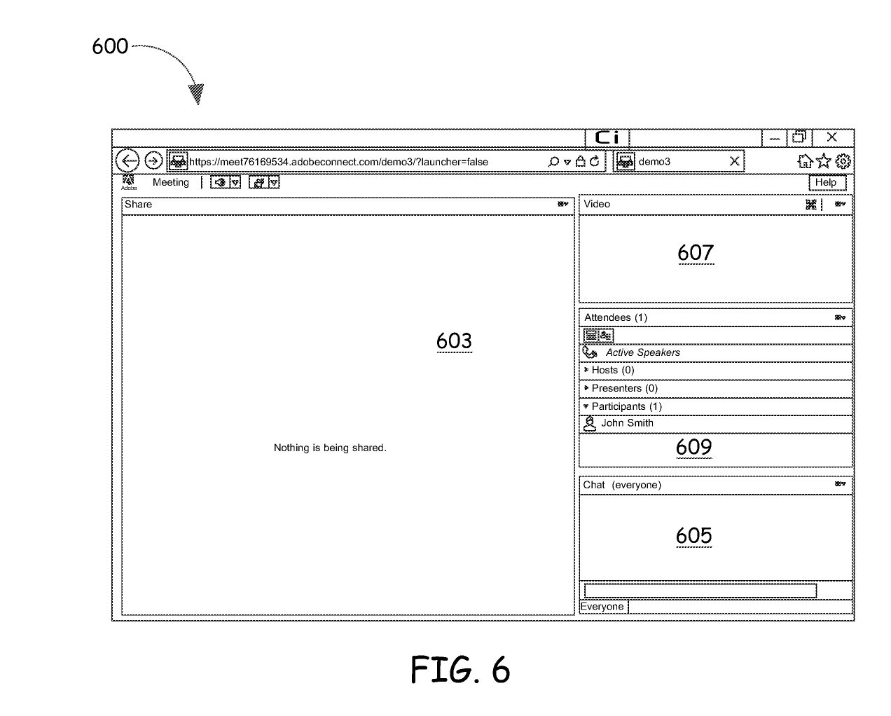

Referring next to FIG. 6 a meeting screen 600 displayed in response to a conference being initiated using web conferencing screen 500 (FIG. 5) is illustrated and discussed according to various embodiments of the present disclosure. Web meeting screen 600 includes share pane 603, video pane 607, attendee pane 609, and chat pane 605. In some embodiments, meeting screen 600 can be provided by the selected conferencing application, while in other embodiments meeting screen 600 is provided by the cross-platform conferencing interface.

Referring next to FIG. 7, a GUI 700 including a general settings window 710 is illustrated and discussed according to various embodiments of the present disclosure. GUI 700 includes audio conferencing object 103, web conferencing object 105, video conferencing object 107, interactive whiteboard object 109, help object 115. Settings object 117 (FIG. 1) is hidden behind general settings window 710. General settings window 710 allows customization of the cross-platform conferencing interface home page.

General settings window 710 includes main apps tab 712, add new main app tab 714, and import/export tab 716. Main apps tab 712, which is shown as active in FIG. 7, includes a first pane 719, which displays the main applications, and second pane 721, which displays information related to a selected main application. Main applications are applications for which a user selectable object, button, or menu item can be displayed on the home screen. Note that each of the conferencing objects 103, 105, 107, and 109, as well as live help object 115, have a corresponding listing in first pane 719.

In FIG. 7, the Audio Conferencing main application is illustrated as selected, and information relating to setup and use of the audio conferencing feature is displayed in second pane 721. Some or all of the information displayed in second pane 721 can be edited via general settings window 710. For example, a logical path to a default audio conferencing application can be displayed, and changed as necessary or desired. Thus, for example, if there are four audio conferencing applications or services accessible via a computer implementing the cross-platform conferencing interface, one of those four audio programs can be chosen as the default active application to be displayed in response to selecting the audio conferencing object 103. The path listed in second pane 721 can point to the location of the application or service—whether that program is installed locally, on a local area network, on a remote network, or is designed to be accessed via a cloud based service. Various arguments and parameters used to access the application can be entered in second pane 721. Additional customization features allow a user to change the appearance of a user selectable object presented on GUI 700, and in some embodiments to mark the main application inactive, so no user selectable object for that application or service is displayed on GUI 700.

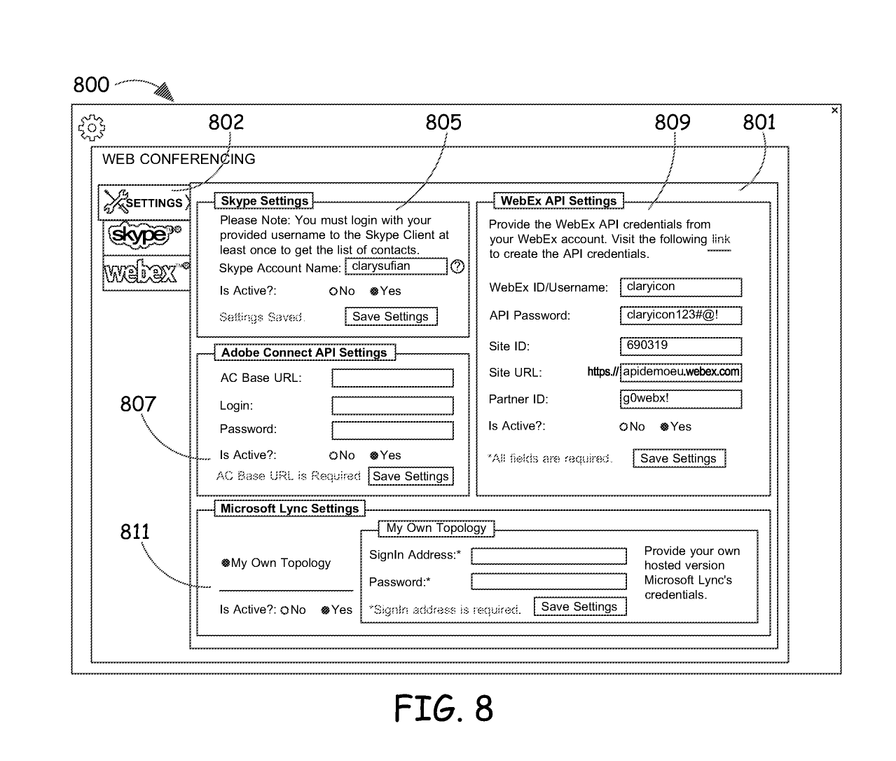

Referring next to FIG. 8 a web conferencing screen 800 will be discussed according to various embodiments of the present disclosure. Web conferencing screen 800 illustrates settings tab 802 as active, and displays a settings window 801 including panes for multiple different web conferencing applications, or services. Settings window 801 includes Skype™ settings 805, Adobe Connect™ API settings 807, Microsoft Lync™ Settings 811, and WebEx™ API settings 809. Settings window 801 allows users a way to record various information that is to be passed from the cross-platform conferencing interface to particular conferencing applications and services. This information can include user names, passwords, uniform resource locators (URLs), partner IDs, or other credentials used by the conferencing applications. In addition, settings window 801 allows users to make particular conferencing applications active. In some embodiments, only active applications have at tab displayed on the various conferencing screens. Note that making an application active does not necessarily make that the default application that is launched in response to choosing a user selectable object from a home screen of the cross-platform conferencing interface.

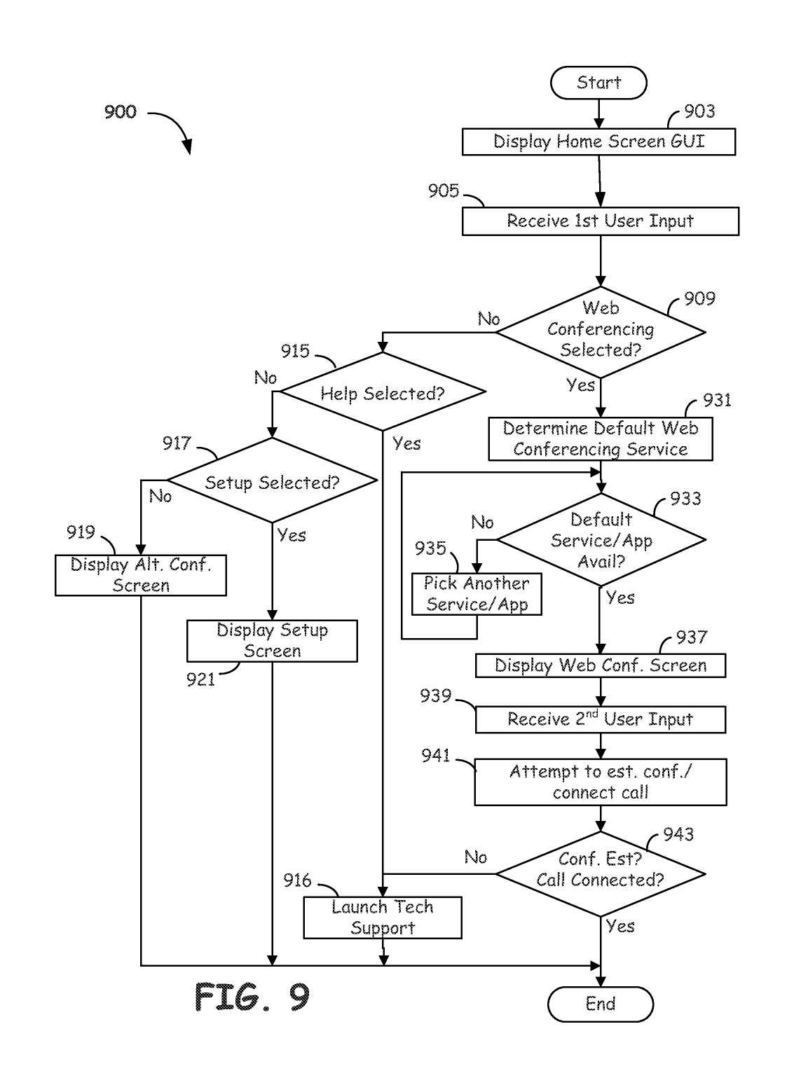

Referring next to FIG. 9 a method 900 is illustrated and discussed according to various embodiments of the present disclosure. Method 900 begins by displaying a home screen GUI, as illustrated by block, 903. In some embodiments, the home screen GUI can be launched automatically upon startup of a computing device implementing a cross-platform conferencing interface. In some embodiments, the home screen GUI can be launched as needed.

Different home screens can be displayed for different users. In some embodiments, a customized home screen is displayed based upon a user's login credentials for an operating system or domain, while in other embodiments a user can log into the program separately from logging in to the operating system or domain.

As illustrate by block 905, first user input is received from the home screen GUI. The first user input is, in some embodiments, a click or other comparable action selecting a main application to run. For example, if a user selects a web conferencing application from the home screen, that selection can be considered to be the first user input. As illustrated by block 909, a check is made to determine whether the first user input was to select web conferencing. Note that although the present method is tailored to web conferencing, similar principles and techniques apply to audio conferencing, video conferencing, and whiteboarding.

If the user input does not indicate web conferencing, a check is made at block 915 to determine if the user input is instead selection of the help function. If the user input received at block 905 corresponds to selection of the help function, tech support is launched, as illustrate by block 916.

If neither web conferencing nor help is selected, a check is made at block 917 to determine whether the setup function was chosen. If the setup function was chosen, a setup screen is displayed, as illustrated by block 921. If the user input is not web conferencing, the help function, or the setup function, then an alternate conference screen is displayed, as illustrated by block 919. For example, if the user input received at block 907 indicates that the user wants to run an audio conferencing application, then an audio conferencing screen can be displayed as the alternate conferencing screen. Likewise, if a user chooses to launch a video conferencing application, a video conferencing screen can be displayed as the alternate conferencing screen.

Returning to consideration of block 909, if it is determined that the first user input received at block 905 is selection of the web conferencing icon, method 900 proceeds to block 931, where the default web conferencing application or service is determined. The default web conferencing application or service can be the web service indicated in a general settings window, such as that shown in FIG. 7, or in some other configuration or setup window. In some instances, if no default conferencing application or service has been specified, a default can be chosen to be the last web conferencing application or service used by a particular user, the last web conferencing application or service used on a particular machine, the most-used web conferencing application or service, the least expensive web conferencing application or service, or by using other suitable criteria.

In some embodiments, a check can be made to determine whether the default web conferencing application or service is available, as illustrated by block 933. If the default web conferencing application is unavailable for any reason, for example if an administrator has marked the default conferencing application as inactive, another web conferencing application is selected at block 935, and the availability of that application is confirmed at block 931, and the newly selected application replaces the default application.

As illustrated by block 937, once the default web conference service has been selected and verified as available, the appropriate uniform web conferencing screen is displayed at block 937. In some embodiments, the uniform web conferencing screen can be used for any and all available web conferencing services, applications, and providers. In other embodiments, one or more web conferencing applications may use non-uniform web conferencing screens.

Note that except for the first user input, which can be, for example, the user clicking on the web conferencing icon on the home page of the cross-platform conferencing application, no other user input is required to select the default web conferencing application. Note that in various embodiments, however, once the web conference screen is displayed at block 937, a user can override the default selection of the web conferencing application by selecting another available web conferencing application or service to use.

Assuming for purposes of this example that the user accepts the system's determination of the default web conferencing application, second user input is received at block 939. In at least some embodiments, the second user input can take the form of the user clicking on a user contact or conference identifier displayed on the web conferencing screen. In response to the second user input, an attempt is made to establish the web conference, as illustrated by block 941. Note that in order to establish the conference, the user does not need to provide more than two user input actions beginning from the home screen. The first input being to select the web conferencing function from the home screen, and the next action to select a communication target from the web conferencing screen.

As illustrated by block 943, a check is made to determine if the conference was established, or the conference call was connected. If the determination if favorable, meaning that the check indicates that the conference call was established, method 900 ends. If, however, the attempt to establish the conference fails, a technical support function can be automatically launched, as illustrated by block 916. The technical support function, in at least one embodiment, includes connecting the user automatically to a live, interactive technical support specialist. In some embodiments, an offer is automatically displayed, and the user can be required to affirmatively accept the offer before being connected to the technical support agent.

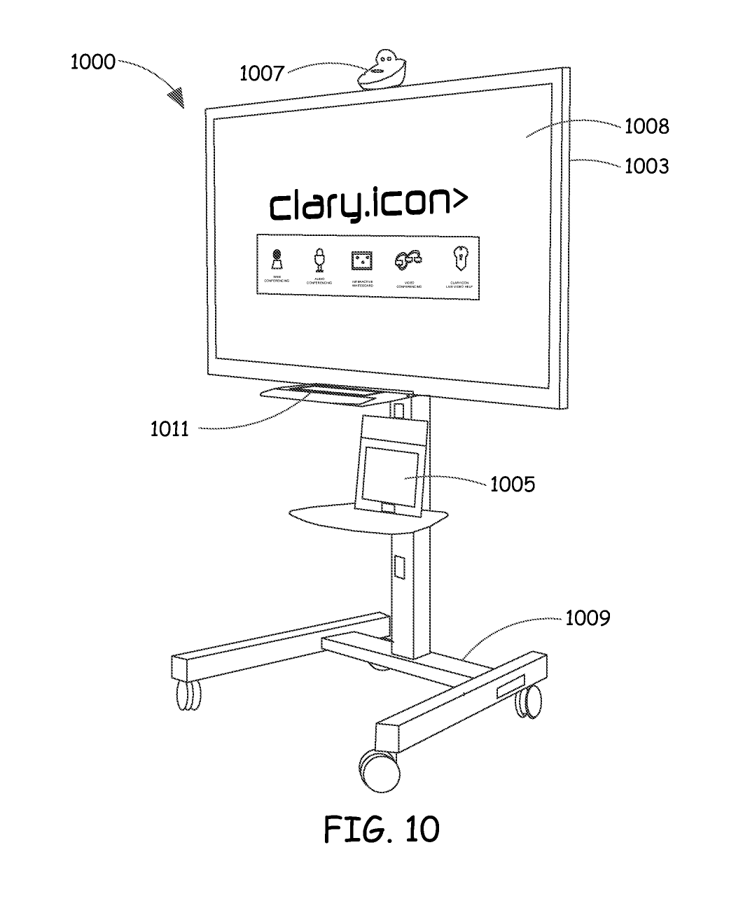

Referring next to FIG. 10 a dedicated conferencing device 1000 will be discussed according to various embodiments of the present disclosure. Dedicated conferencing device 1000 includes touch screen display 1003, which displays cross-platform conferencing interface home page 1008. Dedicated conferencing device 1000 also includes video camera 1007, which in at least one embodiment is a 1080P high definition (HD) pan-tilt-zoom (PTZ) camera featuring precision optics; keyboard 1011; wireless input device 1005, which can include a smart phone, tablet, or other similar device; and a rolling stand. Dedicated conferencing device 1000 can also include although not specifically illustrated, one or more sets of speakers and at least one microphone; hardware configured to support multiple different operating systems and communication platforms; video conferencing software that allows users to make and receive video calls to other H323, SIP, Skype or Google Chat clients; audio conferencing software that allows users to make and receive phone calls from the computer, and web conferencing software that allows users to host or join web conferencing calls. The cross-platform conferencing interface described herein can be used to integrate user access to all these applications on a single screen, which allows a user to initiate any of the above software with a single touch or click.

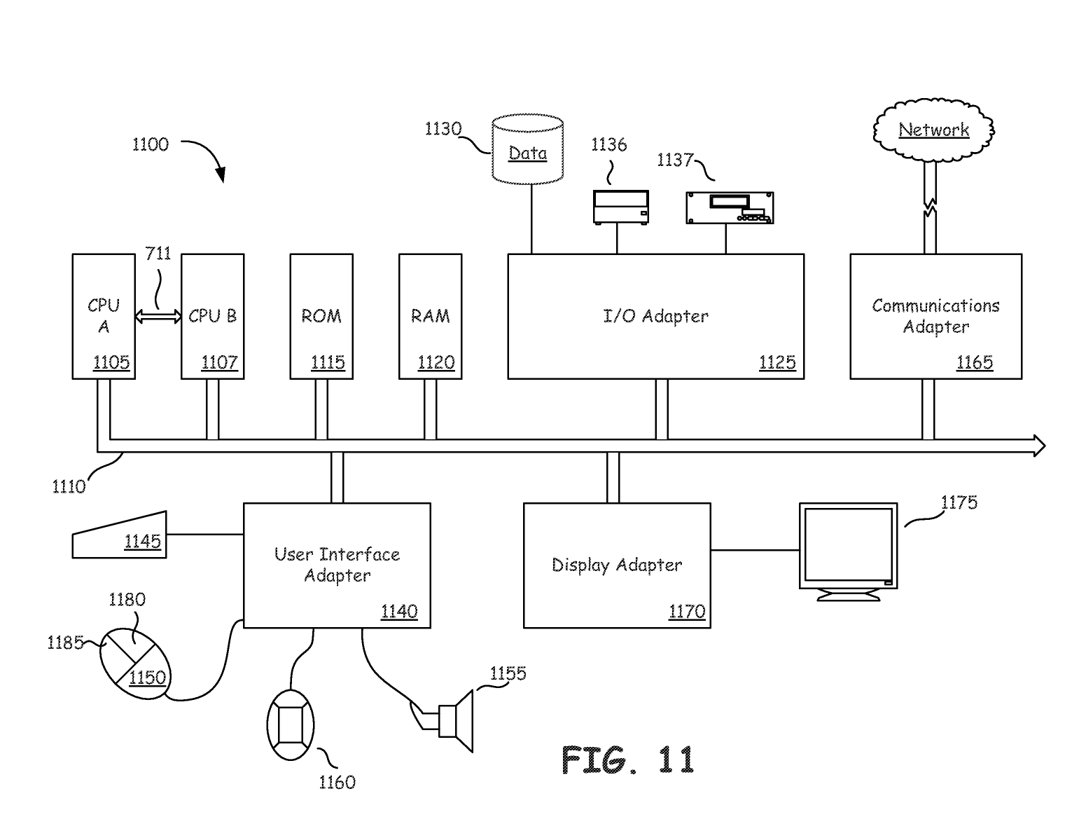

Some or all of the methods and processes described herein, including a dedicated conferencing device, can be embodied in or performed by one or more processing systems. An example of such a processing system is discussed with reference to FIG. 11. Processing system 1100 includes one or more central processing units, such as CPU A 1105 and CPU B 1107, which may be conventional microprocessors interconnected with various other units via at least one system bus 1110. CPU A 1105 and CPU B 1107 may be separate cores of an individual, multi-core processor, or individual processors connected via a specialized bus 1111. In some embodiments, CPU A 1105 or CPU B 1107 may be a specialized processor, such as a graphics processor, other co-processor, or the like.

Processing system 1100 includes random access memory (RAM) 1120; read-only memory (ROM) 1115, wherein the ROM 1115 could also be erasable programmable read-only memory (EPROM) or electrically erasable programmable read-only memory (EEPROM); and input/output (I/O) adapter 1125, for connecting peripheral devices such as disk units 1130, optical drive 1136, or tape drive 1137 to system bus 1110; a user interface adapter 1140 for connecting keyboard 1145, mouse 1150, speaker 1155, microphone 1160, or other user interface devices to system bus 1110; communications adapter 1165 for connecting processing system 1100 to an information network such as the Internet or any of various local area networks, wide area networks, telephone networks, or the like; and display adapter 1170 for connecting system bus 1110 to a display device such as monitor 1175. Mouse 1150 has a series of buttons 1180, 1185 and may be used to control a cursor shown on monitor 1175. Monitor 1175 can be used to display a graphical user interface (GUI), implemented by a program of instructions executed by either or both of CPU A 1105 and CPU B 1107.

It will be understood that processing system 1100 may include other suitable data processing systems without departing from the scope of the present disclosure. For example, processing system 1100 may include bulk storage and cache memories, which provide temporary storage of at least some program code in order to reduce the number of times code must be retrieved from bulk storage during execution.

Various disclosed embodiments can be implemented in hardware, software, or a combination containing both hardware and software elements. In one or more embodiments, the invention is implemented in software stored in a tangible, i.e. non-transitory, computer readable medium, which includes but is not limited to firmware, resident software, microcode, etc. Some embodiments may be realized as a computer program product, and may be implemented as a non-transitory computer-usable or computer-readable medium tangibly embodying program code for use by, or in connection with, a computer, a processor, or other suitable instruction execution system.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The enclosed embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The enclosed embodiments may have also been described, at least in part, in terms of one or more embodiments. One or more embodiments may be used herein to illustrate an aspect thereof, a feature thereof, a concept thereof, and/or an example thereof. A physical embodiment of an apparatus, an article of manufacture, a machine, and/or of a process that embodies the description herein may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

While particular combinations of various functions and features of the enclosed embodiments have been expressly described herein, other combinations of these features and functions are likewise possible. The present invention is not limited by the particular examples disclosed herein and expressly incorporates these other combinations.

What is claimed is:

1. A non-transitory computer readable medium tangibly embodying a program of instructions configured to be stored in a memory and executed by a processor, the program of instructions comprising:
at least one instruction configured to display a graphical user interface (GUI) including a plurality of conferencing options including at least a web conferencing option;
at least one instruction configured to receive first user input selecting the web conferencing option;
at least one instruction configured to display a web conference screen associated with a web conference provider of a plurality of web conference providers, wherein the web conference screen has a uniform layout configured for use with at least two different web conferencing providers of a plurality of web conferencing providers;
at least one instruction configured to receive, via the a web conference screen, second user input associated with the preselected one of the plurality of a web conferencing providers; and
at least one instruction configured to attempt to establish a conference, associated with a user contact, using resources of the preselected one of the plurality of a web conferencing providers.

2. The computer readable medium of claim 1, wherein
the plurality of conferencing options are displayed as user-selectable objects on a dedicated conferencing home screen;
the first user input and the second user input are user clicks; and
the conference can be established in two clicks, starting from the cross-platform conferencing home screen.

3. The computer readable medium of claim 1, further comprising:
at least one instruction configured to present a user the opportunity to connect to a live, audio-visual technical support feed if the attempt to establish the conference fails.

4. The computer readable medium of claim 1, wherein the at least one instruction configured to display a GUI further includes:
at least one instruction to display a user selectable HELP button configured to establish a real-time technical support session in response to being activated.

5. The computer readable medium of claim 1, wherein the plurality of conferencing options includes audio conferencing, web conferencing, video conferencing, and an interactive whiteboard.

6. The computer readable medium of claim 1, wherein the at least one instruction configured to display a GUI further includes:
at least one instruction to display setup options, wherein the setup options include an option to display a conferencing setup screen that includes a plurality of configuration areas corresponding to respective ones of the plurality of web conferencing providers.

7. The computer readable medium of claim 1, wherein the call includes a voice over Internet protocol (VoIP) protocol call capable of connecting both voice and video conference components.

8. A method comprising:
transmitting, from a processor to a display device, information configured to display a graphical user interface (GUI) including a plurality of user selectable objects associated with a plurality of user conferencing options, including at least one user selectable object configured to activate a web conferencing interface;
receiving, at the processor, first user input indicating that the at least one user selectable object has been activated;
in response to receiving the first user input, transmitting, from the processor to the display device, information configured to display a conferencing interface associated with a particular conferencing application included in a plurality of available conferencing applications, the conferencing interface having a uniform layout configured for use with at least two different conferencing applications of the plurality of conferencing applications;
receiving, at the processor, second user input indicating selection of a communication target associated with the particular conferencing application; and
attempting to establish a conference associated with the communication target using resources of the conferencing application.

9. The method of claim 8, wherein
the plurality of user-selectable objects are displayed on a cross-platform conferencing home screen;
the first user input and the second user input are user clicks; and
the conference can be established in two clicks, starting from the cross-platform conferencing home screen.

10. The method of claim 8, further comprising:
connecting the user to a live, audio-visual technical support feed if the processor detects that the attempt to establish the conference has failed.

11. The method of claim 8, wherein the GUI further includes:
a user selectable HELP icon configured to establish a real-time technical support session in response to being activated.

12. The method of claim 8, wherein the plurality of user conferencing options includes at least three of audio conferencing, web conferencing, video conferencing, and an interactive whiteboard.

13. The method of claim 8, wherein the GUI further includes:
a user selectable setup icon configured to display setup options, wherein the setup options include an option to display a conferencing setup screen that includes a plurality of configuration areas corresponding to respective ones of the plurality of conferencing applications.

14. The method of claim 8, wherein the call includes a voice over Internet protocol (VoIP) protocol call capable of connecting both voice and video call components.

15. A conferencing system comprising:
a display configured to display a conferencing home screen including a plurality of user selectable objects associated with a plurality of communication options, including at least one user selectable object configured to activate a conferencing interface associated with any of a plurality of different network communication applications;
a processor configured to receive first user input indicating that the at least one user selectable object has been activated;
the display further configured to display the conferencing interface, wherein the conferencing interface has a uniform layout configured for use with at least two different network communication applications of a plurality of network communication applications;
the processor further configured to receive second user input indicating that establishing a conference associated with a target is to be attempted; and
the processor further configured to attempt establish the conference using resources of the available network communication application.

16. The system of claim 15, wherein
the first user input and the second user input are user clicks; and
the conference can be established in two clicks, beginning at the conferencing home screen.

17. The system of claim 15, the processor further configured to:
present the user a link to a live, audio-visual technical support feed if the processor detects that the attempt to establish the conference has failed.

18. The system of claim 15, wherein the conferencing home screen further includes:
a user selectable HELP object configured to establish a real-time technical support session in response to being activated.

19. The system of claim 15, wherein the plurality of communication options includes at least an audio conferencing option, a web conferencing option, and a video conferencing option.

20. The system of claim 15, wherein the conferencing home screen further includes:
a user selectable settings object configured to display setup options, wherein the setup options include an option to display a conferencing setup screen that includes a plurality of configuration areas corresponding to respective ones of the plurality of conferencing applications.
